(19) United States
(12) Patent Application Publication
(10) Pub. No.: US 2025/0384263 A1
(43) Pub. Date: Dec. 18, 2025

(54) Systems and Methods for Artificial Intelligence (AI) Based Power Distribution Network (PDN) Simulation Efficiency Improvements

(71) Applicant: QUALCOMM Incorporated, San Diego, CA (US)

(72) Inventors: Soumya SOURAV, San Diego, CA (US); Shree Krishna PANDEY, San Diego, CA (US); Lindsey Makana KOSTAS, San Diego, CA (US)

(21) Appl. No.: 18/744,044

(22) Filed: Jun. 14, 2024

(51) Int. Cl. G06N 3/08

(52) U.S. Cl. CPC G06N 3/08

(57) ABSTRACT

Various embodiments include methods and computing devices implementing the methods for predicting a voltage deviation, i.e., a voltage undershoot (voltage droop) or a voltage overshoot, in a plurality of power distribution network (PDN) configurations. Various embodiments may include generating training data using a circuit simulator, in which the training data includes current waveforms and voltage waveforms associated with a plurality of PDN configurations. The generated training data may be used to train a CRNN model configured to process time-domain current vectors and frequency-domain impedance profiles. The trained CRNN model may then be used to generate a voltage deviation prediction by applying current waveforms and impedance profiles of different PDN configurations to the trained CRNN model. A plurality of PDN configuration options may be evaluated in parallel, and recommendations for PDN configurations may be determined based on the generated voltage deviation prediction and generated evaluation results.

### SYSTEMS AND METHODS FOR ARTIFICIAL INTELLIGENCE (AI) BASED POWER DISTRIBUTION NETWORK (PDN) SIMULATION EFFICIENCY IMPROVEMENTS

### BACKGROUND

Power distribution networks (PDNs) deliver power from the power management integrated circuit (PMIC) to chip IP blocks. Voltage overshoot and undershoot, phenomena occurring in PDNs, result from parasitic resistance and inductance within the network. This voltage overshoot and undershoot may cause fluctuations in the power delivered to the chip IP blocks, potentially impacting the overall performance and stability of the system.

### SUMMARY

Various aspects include methods and computing devices implementing the methods for predicting voltage overshoot and undershoot in power distribution network (PDN) configurations. Various aspects may include a computing device, including a memory, and at least one processor coupled to the memory and configured to generate training data using a circuit simulator, wherein the training data includes current waveforms and voltage waveforms associated with a plurality of power distribution network (PDN) configurations, use the generated training data to train a convolutional recurrent neural network (CRNN) model configured to process time-domain current vectors and frequency-domain impedance profiles, and generate a voltage overshoot and undershoot prediction by applying current waveforms and impedance profiles of different PDN configurations to the trained CRNN model.

In some aspects, the at least one processor may be further configured to use the generated voltage overshoot and undershoot prediction to evaluate a plurality of PDN configuration options in parallel and generate evaluation results. In some aspects, the at least one processor may be further configured to generate recommendations for PDN configurations based on the generated voltage overshoot and undershoot prediction and generated evaluation results.

In some aspects, at least one processor may be further configured so that one or more intermediate CNN models reduce the impedance profile into feature embeddings and input a combination of time domain data and the embeddings to the CRNN model to capture temporal dependencies and relationships. In some aspects, at least one processor may be further configured to generate training data by performing operations that include determining boundary voltage levels for training the CRNN model and intermediate voltage levels for testing the trained CRNN model.

Further aspects include methods of predicting voltage overshoot and undershoot in a PDN configuration that may include generating training data using a circuit simulator, wherein the training data includes current waveforms and voltage waveforms associated with a plurality of PDN configurations, using the generated training data to train a CRNN model configured to process time-domain current vectors and frequency-domain impedance profiles, and generating a voltage overshoot and undershoot prediction by applying current waveforms and impedance profiles of different PDN configurations to the trained CRNN model.

Some aspects may further include using the generated voltage overshoot and undershoot prediction to evaluate a plurality of PDN configuration options in parallel and generate evaluation results. Some aspects may further include generating recommendations for PDN configurations based on the generated voltage overshoot and undershoot prediction and generated evaluation results.

Some aspects may further include reducing impedance profile data into feature embeddings using one or more intermediate CNN models of the CRNN model and feeding the CRNN model a combination of time domain data and the embeddings to capture temporal dependencies and relationships.

Some aspects may further include generating training data by performing operations that include determining boundary voltage levels for training the CRNN model and intermediate voltage levels for testing the trained CRNN model.

Further aspects may include a non-transitory processor-readable medium having stored thereon processor-executable instructions configured to cause a processor of a computing device to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating example components in system in package (SIP) that may be included in a computing device and configured to implement some embodiments.

FIGS. 2-4 are component block diagrams illustrating components and operations in an example computing system that could be configured to use AI to improve the efficiency of a PDN simulation in accordance with some embodiments.

FIGS. 5-7 are process flow diagrams illustrating methods of using AI to improve the efficiency of a PDN simulation in accordance with some embodiments.

FIG. 8 is a component block diagram illustrating an example computing device in the form of a laptop that is suitable for implementing some embodiments.

FIG. 9 is a component block diagram illustrating an example wireless communication device suitable for use with various embodiments.

FIG. 10 is a component diagram of an example server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include an AI-based power distribution network (PDN) simulation efficiency improvement (APSEI) system or component that uses advanced neural network architectures to estimate PDN voltage overshoot and undershoot for circuit designs, enabling efficient determination of minimum power level settings for power control components. By leveraging neural networks and circuit simulation techniques, designers may quickly identify optimal configurations with reduced energy consumption while maintaining system reliability under various scenarios and constraints. Using a trained neural network to estimate PDN voltage overshoot and undershoot may save developers time and costs associated with configuring power distribution networks and controllers for complex integrated circuits to ensure performance and power consumption requirements are satisfied.

The term “power distribution network” (PDN) is used herein to refer to a network within a computing device that delivers electrical power from a power management integrated circuit (PMIC) to various integrated circuit (IC) blocks. The PDN may include various components and resources (e.g., power rails, interconnects, decoupling capacitors, etc.) that collectively maintain the voltage levels across the device’s circuitry. The PDN may be responsible for mitigating issues related to parasitic resistance and inductance, which may cause voltage overshoot and undershoot and affect the performance and stability of the system.

The term “voltage deviation” is used herein to refer to any departure from the nominal or desired voltage level within a power distribution network (PDN). Voltage deviation encompasses both voltage overshoot (e.g., a temporary increase in voltage, etc.) and voltage undershoot (e.g., a temporary decrease in voltage, etc). These deviations may occur during periods of sudden load changes or transient conditions and may result from parasitic resistance and/or inductance inherent in the network components and the power distribution network.

The terms “voltage droop” and “voltage undershoot” may be used interchangeably herein to refer to a temporary reduction in voltage levels within a power distribution network (PDN) that occurs due to the inherent parasitic resistance and inductance of the network components. Voltage droop/voltage undershoot may manifest as a decrease in the supply voltage delivered to integrated circuit (IC) blocks (e.g., during periods of high current demand or sudden load changes, etc.). This phenomenon may negatively impact the performance and stability of electronic systems because it may lead to slower processing speeds, increased power loss, and higher operational temperatures.

The term “voltage overshoot” is used herein to refer to a temporary increase in voltage levels within a PDN that occurs due to the parasitic resistance and inductance of the network components. Voltage overshoot may manifest as an increase or spike in the supply voltage delivered to IC blocks (e.g., during periods of sudden load reduction or transient conditions, etc.). This phenomenon may negatively impact the performance and stability of electronic systems because it may damage sensitive components, cause instability or excessive power dissipation, etc.

For ease of description, some examples address the case of a voltage droop type of voltage deviation. However, nothing in this application should be used to limit the claims to “voltage droop” or “voltage undershoot” unless expressly recited as such within the body of the claims.

The term “computing device” is used herein to refer to (but not limited to) any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo switch™), media players (e.g., DVD players, Roku™, apple TV™), digital video recorders (DVRs), portable projectors, 3D holographic displays, wearable devices (e.g., earbuds, smartwatches, fitness trackers, augmented reality (AR) glasses, head-mounted displays, etc.), vehicle systems such as drones, automobiles, motorcycles, connected vehicles, electric vehicles, automotive displays, advanced driver-assistance systems (ADAS), etc., cameras (e.g., surveillance cameras, embedded cameras), smart devices (e.g., smart light bulbs, smartwatches, thermostats, smart glasses, etc.), Internet of Things (IOT) devices, other similar devices that include a programmable processing system that may be configured to provide the functionality of various embodiments.

The term “processing system” is used herein to refer to one or more processors, including multi-core processors, that are organized and configured to perform various computing functions. Various embodiment methods may be implemented in one or more of multiple processors within a processing system as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC’s main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) is used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process that is performed at runtime or during the execution of the software application program corresponding to the neural network. Inference may include traversing the processing nodes in the neural network along a forward path to produce one or more values as an overall activation or overall “inference result.”

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in-between the input and final layer may be referred to as intermediate layers, hidden layers, or black-box layers.

Each layer in a neural network may have multiple inputs and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

The term “recurrent neural network” (RNN) is used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “convolutional neural network” (CNN) is used herein to refer to a class of deep neural networks that are particularly effective for processing images, spatial data, data with a grid-like topology. A CNN may use convolutional layers that apply a series of filters to the input data to detect and learn spatial hierarchies of features. Each convolutional layer may generate a set of activation maps that highlight the presence of specific features detected by the filters. These activation maps may then be passed through pooling layers that reduce their dimensionality and help to generalize the model by making it more invariant to small transformations in the input data. The output of the final convolutional and pooling layers may be fed into fully connected layers that perform the final classification or regression tasks. CNNs are widely used in image recognition, object detection, and other applications involving spatial data.

The term “convolutional recurrent neural network” (CRNN) is used herein to refer to a hybrid neural network architecture that combines the spatial feature extraction capabilities of convolutional neural networks (CNNs) with the temporal sequence processing abilities of a recurrent neural network (RNN). CRNNs may be particularly effective for tasks involving sequential data with spatial dependencies (e.g., video analysis, speech recognition, time-series forecasting, etc.). The initial layers of a CRNN may be convolutional layers that process and extract features from the input data. These features may be fed into recurrent layers, such as long short-term memory (LSTM) or gated recurrent unit (GRU) layers, which model the temporal dependencies in the data. This combination may allow the CRNN to handle complex patterns in both space and time.

The term “long short-term memory network” (LSTM) is used herein to refer to a specific type of RNN that addresses some of the limitations of basic RNNs, particularly the vanishing gradient problem. LSTMs include a more complex recurrent unit that allows for the easier flow of gradients during backpropagation. This facilitates the model’s ability to learn from long sequences and remember over extended periods, making it apt for tasks such as language modeling, machine translation, and other sequence-to-sequence tasks.

The term “generalizability” is used herein to refer to a characteristic, value, or metric that measures the capability of a model or system to apply what it has learned from training data to new and/or unseen data. Generalizability may indicate how well the model can perform on different datasets beyond the specific examples it was trained on and, thus, its ability to adapt and provide accurate predictions or outputs in varied contexts and conditions. A high generalizability may indicate that the AI model is robust and reliable in real-world applications (not just in controlled or limited scenarios).

The term “circuit simulator” is used herein to refer to a software tool or application that models the behavior of electronic circuits. Circuit simulators may allow for the analysis and testing of circuit designs by simulating their operation under various conditions and configurations. These tools may generate detailed current and voltage waveforms, impedance profiles, and other electrical characteristics, providing insight into the performance, stability, and efficiency of the circuits. Common circuit simulators include tools such as Hspice and Advanced Design System (ADS), which are used to verify and optimize circuit designs before physical implementation.

The term “generated waveform” is used herein to refer to a digital representation of the variations in current or voltage over time as produced by a circuit simulator. These waveforms may capture the dynamic electrical behavior of a circuit under various conditions and configurations. A generated waveform may include discrete data points that reflect the instantaneous values of current or voltage at specific moments and/or that otherwise provide detailed insight into the circuit’s performance. Example data structures for storing or representing the generated waveform include arrays, linked lists, time-series objects, data frames, buffers, and sparse matrices, each suited to efficiently manage and analyze the temporal data.

The term “boundary voltage levels” is used herein to refer to the edge voltage values used during the training phase of the neural network models. These levels may represent the highest and lowest voltages within the dynamic current and voltage scaling (DCVS) range of the power distribution network (PDN). Boundary voltage levels (or “edge DCVS voltage levels”) may be important for establishing the boundaries within which the model learns to predict voltage deviation (e.g., a voltage droop or a voltage overshoot). By training on these extreme values, the model may better understand the full spectrum of voltage variations and improve its ability to generalize to real-world conditions. These levels may provide a comprehensive view of the behavior of the PDN under demanding operating conditions and/or may be used to accurately predict performance across the entire voltage range.

The term “intermediate voltage levels” is used herein to refer to the voltage values within the range established by the boundary voltage levels but not at the boundaries or extremes. These levels may be used during the testing phase to validate the accuracy and generalizability of the neural network models. Intermediate voltage levels may provide a realistic representation of typical operating conditions, allowing for the assessment of the model’s performance in predicting voltage deviation (e.g., a voltage droop or a voltage overshoot) under standard usage scenarios.

The term “impedance profile data” is used herein to refer to information structures or units that include or capture the impedance characteristics of a PDN across various frequencies. This data may encapsulate the resistance, inductance, and capacitance properties of the network components and provide a comprehensive view of how impedance varies with frequency. Some embodiments may include components configured to generate or use the impedance profile data to understand and predict the electrical behavior of the PDN under different operating conditions. Some embodiments may include components configured to apply the impedance profile data to neural network models (e.g., CRNN, etc.), which may use this data to generate feature embeddings that capture important characteristics of the frequency-domain information.

The term “transfer learning” is used herein to refer to a machine learning technique in which a pre-trained model developed for a generic task is adapted and fine-tuned for a more specific task. These operations may include using the knowledge gained from a pre-trained model (a model that has already been trained on a large dataset, etc.) to improve the performance and efficiency of the model on a new but related problem with limited data. Some embodiments may include components configured to use pre-trained models that have learned generic PDN behavior patterns and subsequently fine-tune these models with domain-specific data to accurately predict voltage deviation (e.g., a voltage droop or a voltage overshoot) and other relevant metrics. Such transfer learning operations may reduce training time and the use or computational resources while enhancing the model’s ability to generalize and perform accurately under various scenarios and configurations.

Generally, there are significant technical challenges associated with managing and maintaining power distribution across chip IP blocks due to voltage deviation (e.g., a voltage droop or a voltage overshoot) resulting from parasitic resistance and inductance. Conventional circuit simulators (e.g., Hspice, Advanced Design System (ADS), etc.) are inadequate for use with PDNs due to the complexity and variability associated with tasks such as managing multiple power rails, dealing with diverse input patterns or unique vectors and their varying lengths, accommodating different performance modes, and adjusting to varying temperature conditions.

In some embodiments, the APSEI component may be configured to overcome these and other technical challenges by using a convolutional recurrent neural network (CRNN) model to predict voltage as a function of time based on various values, parameters, and conditions (e.g., current waveforms, dynamic current and voltage scaling (DCVS) levels, etc.).

In some embodiments, the APSEI component may be configured to collect training data from a circuit simulator and use the collected training data to generate current and voltage waveforms for multiple different PDN configurations. The generated waveforms may characterize or represent electrical current and voltage over time for different PDN configurations, capture fluctuations under different operating conditions, and provide insight into the behavior and performance of each configuration. The APSEI component may use these generated waveforms to analyze and improve the PDN. For example, in some embodiments, the APSEI component may be configured to generate and use the waveforms to verify efficient power delivery or reduced or minimized voltage deviation (e.g., a voltage droop or a voltage overshoot) across the integrated circuit blocks.

In some embodiments, the APSEI component may be configured to remove vertical and horizontal biases from the generated waveforms. For example, the APSEI component may normalize the waveforms to a constant, consistent, or reliable direct current (DC) level and decompose them into individual measurements.

In some embodiments, the APSEI component may be configured to remove vertical bias by normalizing the input waveforms, bringing them to a consistent DC level, and adding the DCVS voltage level as an additional feature. In some embodiments, the APSEI component may be configured to remove horizontal bias by treating waveforms as individual measurements and decomposing them to eliminate time dependence.

In some embodiments, the APSEI component may be configured to use various techniques or technologies to further enhance the training data. For example, in some embodiments, the APSEI component may be configured to use a shuffled sliding window data representation scheme to augment or enhance the training data. The shuffled sliding window data representation scheme may be a method of augmenting training data by creating overlapping segments (windows) of the original dataset and then shuffling the segments so that each window captures a sequence of data points, maintaining the temporal order within the window while introducing variability across the dataset. This approach may improve or enhance the generalizability of the training data by increasing the diversity of samples and/or may allow the model to learn more robustly from different parts of the dataset while preserving the inherent sequential relationships in the data. Said another way, the APSEI component may be configured to use a shuffled sliding window data representation scheme to improve the generalizability of the training data while preserving its sequential order. This may, in turn, allow the neural network to more accurately learn and generalize from the data.

In some embodiments, the APSEI component may be configured to initialize a CRNN model to process time-domain current vectors and frequency-domain impedance profiles. The APSEI component may train the CRNN model using edge DCVS voltage levels (e.g., boundary voltage levels, etc.) and test it using intermediate voltage levels as explained above. These operations may enhance the speed and accuracy of predicting voltage drop across various PDN configurations.

In some embodiments, the APSEI component may be configured to use the CRNN model for joint processing of time-domain and frequency-domain data without relying on computationally expensive methods such as Fast Fourier Transform (FFT). Instead, the APSEI component may use a convolutional neural network (CNN) to reduce impedance profile data into feature embeddings that efficiently merge frequency and time-domain data. As a result, the CRNN model may effectively and accurately manage variable impedance profiles, overcoming technical challenges posed by variations in resistance (R), inductance (L), and capacitance (C) of the PDN. In some embodiments, the APSEI component may train the CRNN model using a single impedance profile. In some embodiments, the APSEI component may train the CRNN model using multiple impedance profiles.

During the inference phase, the APSEI component may use the trained CRNN model to process unseen current waveforms and impedance profiles and predict voltage deviation (e.g., a voltage droop or a voltage overshoot). The APSEI component may evaluate multiple PDN options in parallel for faster and improved identification of enhanced configurations with lower voltage deviation (e.g., a voltage droop or a voltage overshoot).

In some embodiments, the APSEI component may be configured to use a CRNN to handle the complexity of PDN simulations by processing both time-domain current vectors and frequency-domain impedance profiles. The CRNN model may address the challenge of variable impedance profiles by reducing impedance data into feature embeddings through a CNN model, simplifying the integration of frequency and time-domain data. These operations may reduce computational complexity and inference time to provide a more efficient solution for PDN optimization or enhancement.

In some embodiments, the APSEI component may be configured to train the neural network on specific impedance profiles while ensuring generalization to other profiles. Since direct parametrization of impedance may a computationally intensive task, the APSEI component may calculate embeddings from impedance using an intermediate model, reducing complexity and allowing effective data merging. Such data representation and joint processing architecture may allow the APSEI component to align and remove bias from vectors of different lengths, PMIC levels, and time scales.

In some embodiments, the APSEI component may be configured to support various applications. For example, the APSEI component may generate voltage versus time waveforms during PDN simulations and/or may be used to generate PDN configuration optimization information. The APSEI component may allow designers to quickly evaluate and improve PDN configurations and/or otherwise enhance the performance and reliability of computing devices.

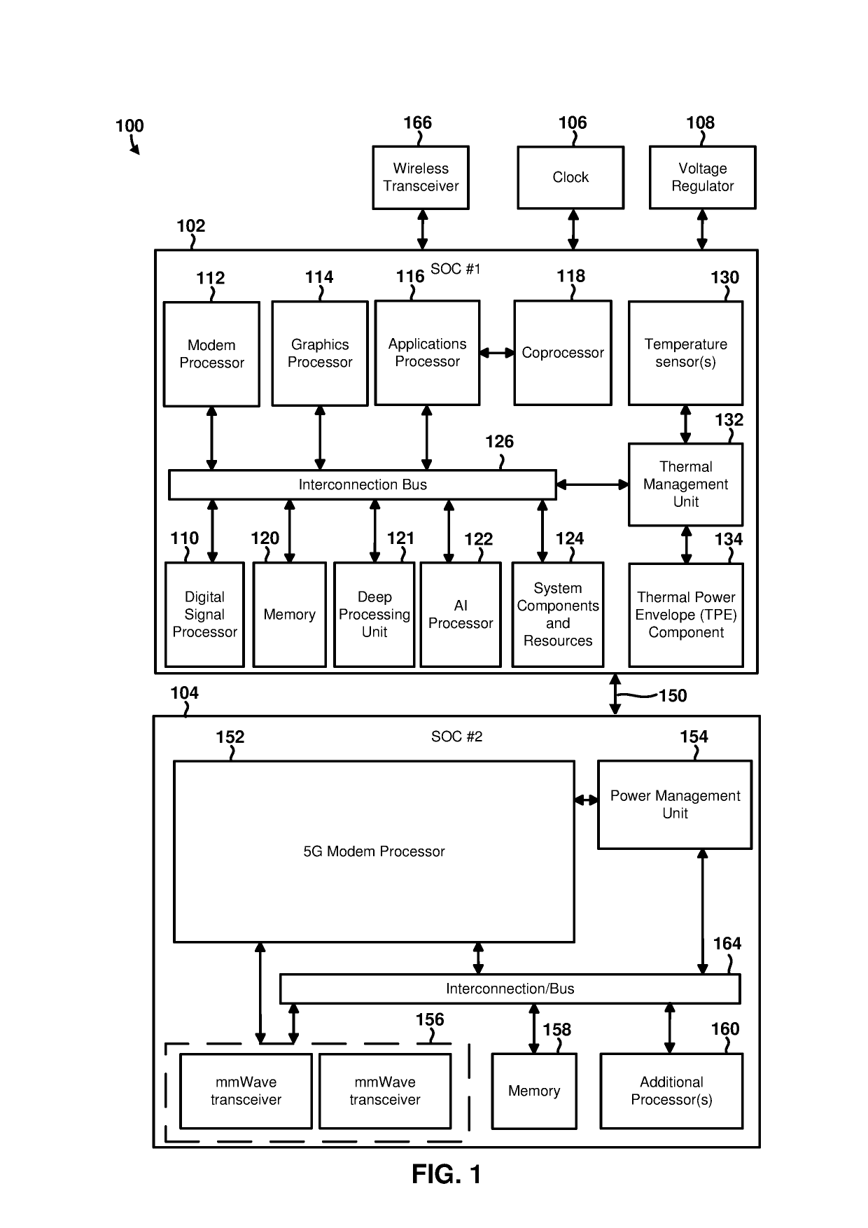

Various embodiments may be implemented on a number of single-processor and multiprocessor computer systems, including a system-on-chip (SOC) or system in a package (SIP). FIG. 1 illustrates an example computing system or SIP 100 architecture that may be used in user end devices implementing the various embodiments.

With reference to FIG. 1, the illustrated example SIP 100 includes two SOCs 102, 104, a clock 106, a voltage regulator 108, and a wireless transceiver 166. The first and second SOC 102, 104 may communicate via interconnection bus 150. Various processors 110, 112, 114, 116, 118, 121, 122, may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mmWave transceivers 156, memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any, or all of the processors 110, 112, 114, 116, 121, 122, in the system may operate as the SoC’s main processor, central processing unit (CPU), microprocessor unit (MPU), arithmetic logic unit (ALU), etc. One or more of the coprocessors 118 may operate as the CPU.

In some embodiments, the first SOC 102 may operate as the central processing unit (CPU) of the mobile computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, deep processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, a plurality of mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any, or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any, or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node’s computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as a clock 106, a voltage regulator 108, and a wireless transceiver 166 (e.g., cellular wireless transceiver, Bluetooth transceiver, etc.). Resources external to the SOC (e.g., clock 106, voltage regulator 108, wireless transceiver 166) may be shared by two or more of the internal SOC processors/cores.

In some embodiments, the memory 120, 158 may be configured to efficiently store and process large amounts of data generated by a circuit simulator for training an artificial intelligence (AI) model that predicts voltage deviation (e.g., a voltage droop or a voltage overshoot) in power distribution networks (PDNs). In some embodiments, a processing system (which may include any or all of the processors 110, 112, 114, 116, 118, 121, 122, 121, 122, 152, 160 discussed above) may generate current waveforms and impedance profiles associated with multiple PDN configurations using edge dynamic current scaling levels during both initial model development (“training”) and later on while evaluating its performance. The generated data may be stored in a memory 120, 158 configured to handle large datasets.

In some embodiments, the memory 120, 158 may use shuffling segments of training data through a shuffled sliding window scheme to enhance generalizability by introducing variability across the dataset while maintaining temporal order within each segment. This approach may help prevent overfitting and allow the network to learn patterns and relationships between different parts of the dataset more effectively. The processing system may also use various techniques, such as normalizing input waveforms or removing vertical bias from data points.

In some embodiments, the memory 120, 158 may be configured with a convolutional recurrent neural network (CRNN) model that combines spatial feature extraction capabilities of CNNs with temporal sequence processing abilities of RNNs to predict voltage deviation (e.g., a voltage droop or a voltage overshoot) based on current waveforms and impedance profiles. The CRNN model may be trained using edge DCVS levels as an additional input, allowing it to learn how different scaling settings affect PDN behavior under various operating conditions.

In addition to the example SIP 100 discussed above, various embodiments may be implemented in various computing systems, including a single processor, multiple processors, multicore processors, or any combination thereof.

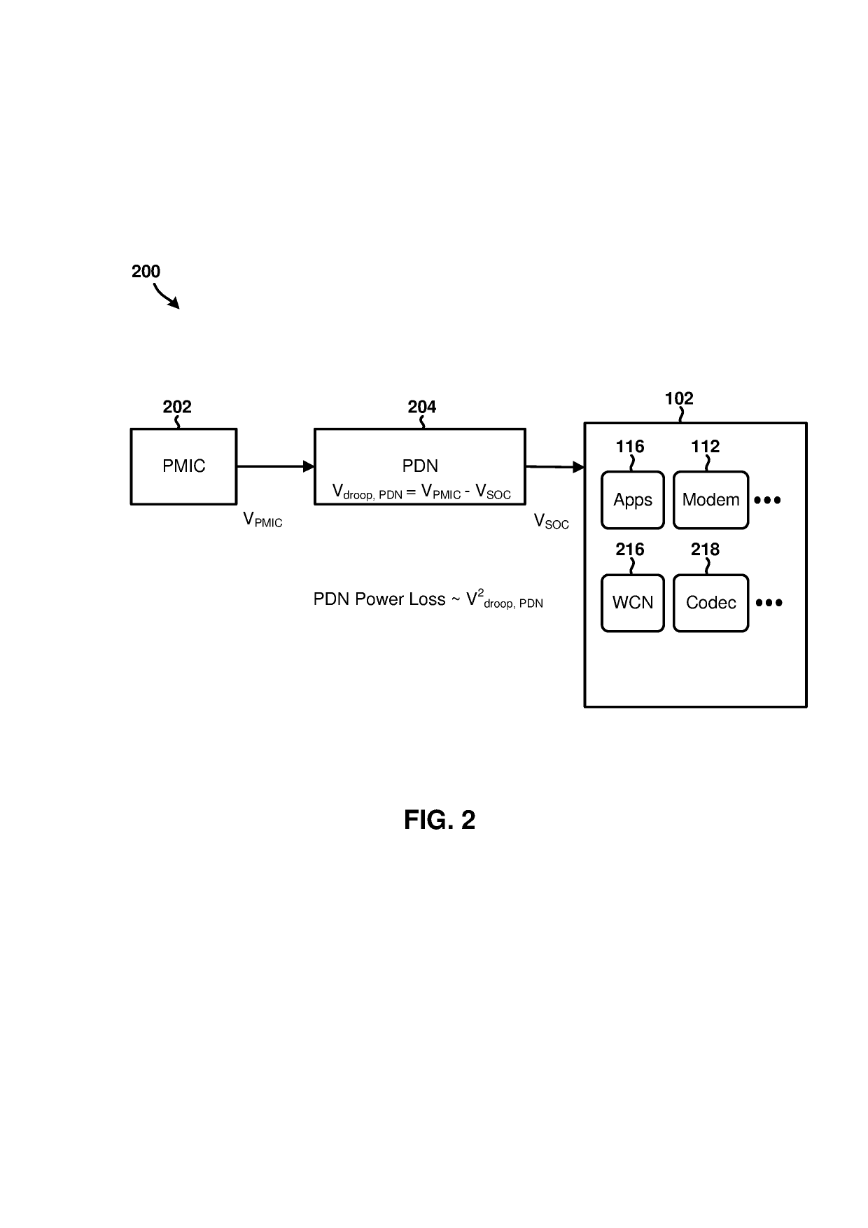

FIG. 2 is a component block diagram illustrating an example computing system 200 that includes a power distribution network (PDN) in accordance with some embodiments. With reference to FIGS. 1 and 2, the computing system 200 may include a power management integrated circuit (PMIC) 202, a PDN 204, and an SOC 102.

The PMIC 202 may generate a supply voltage V_{PMIC} that is delivered to the PDN 204. The PDN 204 may manage the distribution of this voltage to the SoC 102, for which the voltage droop V_{droop,PDN} is defined as V_{PMIC}−V_{SOC} . This voltage droop may lead to power loss within the PDN 204 that is approximately proportional to V²_{droop,PDN}.

The SoC 102 may include various components such as application processors (Apps) 116, modem processors (Modem) 112, wireless communication network (WCN) processors 216, and codec processors 218. These components may require stable voltage levels to operate efficiently. In some embodiments, the PDN 204 may be configured to maintain stable voltage levels for such components by mitigating voltage droop. The PDN 204 may optimize or enhance power delivery by reducing voltage droop across different operating conditions and configurations so that the SoC components receive the necessary power levels for adequate performance. Reducing the voltage droop may also be important for reducing power loss, enhancing efficiency, and maintaining the reliability of the overall system.

In some embodiments, the computing system 200 may include an APSEI component (not illustrated in FIG. 2). In some embodiments, the APSEI component may be implemented by any or all of the processors 110, 112, 114, 116, 118, 121, 122, 121, 122, 152, 160 included in the SIP 100 or SOC 102, 104. In some embodiments, the APSEI component may be configured to use advanced techniques and technologies (e.g., a CRNN model, etc.) to predict and manage voltage drops, enhance the speed and accuracy of PDN simulations, and provide valuable insights for improving the PDN configuration.

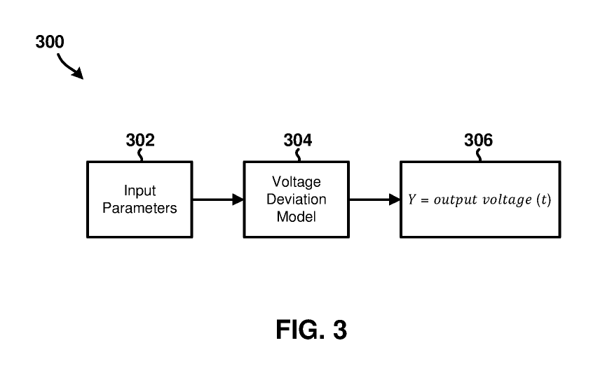

FIG. 3 is a component block diagram illustrating an example computing system 300 that could be configured in accordance with some embodiments. With reference to FIGS. 1-3, the computing system 300 may include input parameters 302, a voltage droop model 304, and an output 306 component.

The input parameters 302 may include various data points necessary for the voltage droop model 304 to make accurate predictions. These parameters may include or relate to current waveforms, voltage levels, impedance profiles, temperature conditions, and other relevant characteristics of the PDN and its operating environment.

The voltage droop model 304 may process the input parameters 302 to predict the voltage droop within the PDN. The voltage droop model 304 may use advanced neural network architectures (e.g., CRNN, etc.) to better manage the complexity of the data and generate more accurate predictions.

The output 306 component may represent the results generated by the voltage droop model 304, which may include predictions of voltage droop across various PDN configurations and operating conditions. These predictions may be used to adjust the PDN configurations to improve power delivery, reduce voltage droop, or otherwise improve the performance and reliability of the overall computing system.

In some embodiments, the computing system 200 may include an APSEI component (not illustrated in FIG. 2). In some embodiments, the APSEI component may be implemented by any or all of the processors 110, 112, 114, 116, 118, 121, 122, 121, 122, 152, 160 included in the SIP 100 or SOC 102, 104. In some embodiments, the APSEI component may be configured to further analyze the output 306 to generate recommendations for PDN configurations that reduce or minimize voltage droop and improve power efficiency. In some embodiments, the APSEI component may be configured to iteratively perform the prediction and optimization operations to generate data that may be used to design robust and efficient PDNs for advanced computing systems.

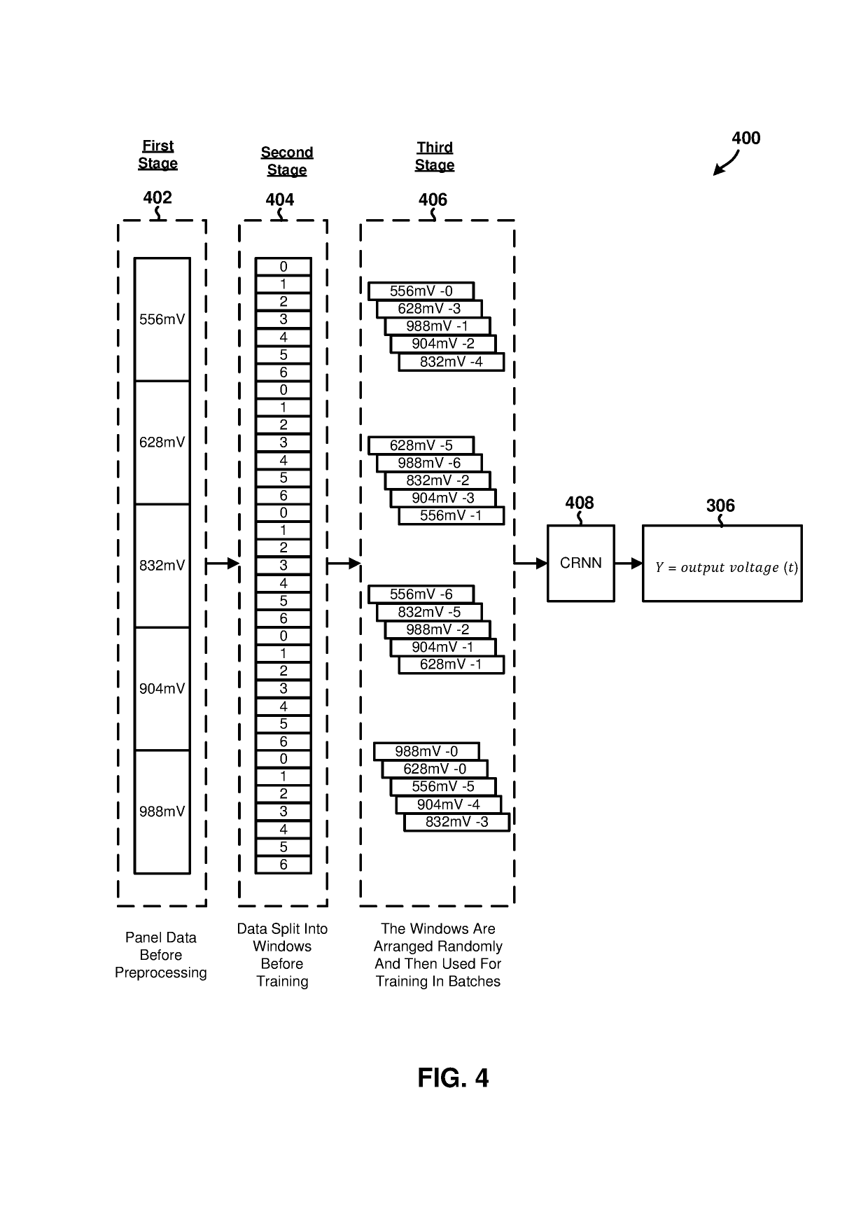

FIG. 4 is a component block diagram illustrating components and operations in an example system 400 that may be configured to use a shuffled sliding window data representation scheme to augment or enhance training data in accordance with some embodiments. With reference to FIGS. 1-4, the computing system 400 may include a sequence of processing stages 402, 404, 408, any or all of which may be performed by an APSEI component implemented by any or all of the processors 110, 112, 114, 116, 118, 121, 122, 121, 122, 152, 160 included in the SIP 100 or SOC 102, 104. For ease of illustration, FIG. 4 refers to specific voltages as examples of voltages (e.g., 556mV, 628mV, 832mV, 904mV, 988mV) that may be used in evaluating a PDN and developing training data. However, these voltage examples are for illustrative purposes, and different voltages may be used without deviating from the embodiments. For example, 556mV is referred to herein as “DCVS Level 1,” 628mV is referred to herein as “DCVS Level 2,” 832mV is referred to herein as “DCVS Level 3,” 904mV is referred to herein as “DCVS Level 4,” and 988mV is referred to herein as “DCVS Level 5.”

The first stage 402 may include panel data before preprocessing and various voltage levels DCVS Level 1, DCVS Level 2, DCVS Level 3, DCVS Level 4, and DCVS Level 5 (e.g., 556mV, 628mV, 832mV, 904mV, 988mV) recorded over time.

In the second stage 404, data may be split into windows before the training. In some embodiments, this may be accomplished by dividing the panel data into smaller overlapping segments or windows. Each window may capture a subset of the data and preserve the temporal sequence within that segment.

In the third stage 406, the windows may be arranged randomly and used for training in batches. The windows and the voltage levels (i.e., DCVS Level 1, DCVS Level 2, DCVS Level 3, DCVS Level 4, and DCVS Level 5) may be shuffled to introduce variability and prevent the model from learning the order of the data sequences (thereby enhancing generalizability, etc.). The examples of shuffling of windows and voltage levels shown in FIG. 4 are for illustration purposes only, and different window numbers and voltage levels will be used in practice. The shuffled windows may be input into the CRNN 408. The CRNN 408 may process the time-domain current vectors and frequency-domain impedance profiles to predict the output voltage Y as a function of time (t).

The shuffled sliding window data representation scheme illustrated in FIG. 4 may allow computing system 400 to generate robust training data that improves the accuracy and efficiency of the CRNN model 408 and improves PDN optimization and voltage droop predictions.

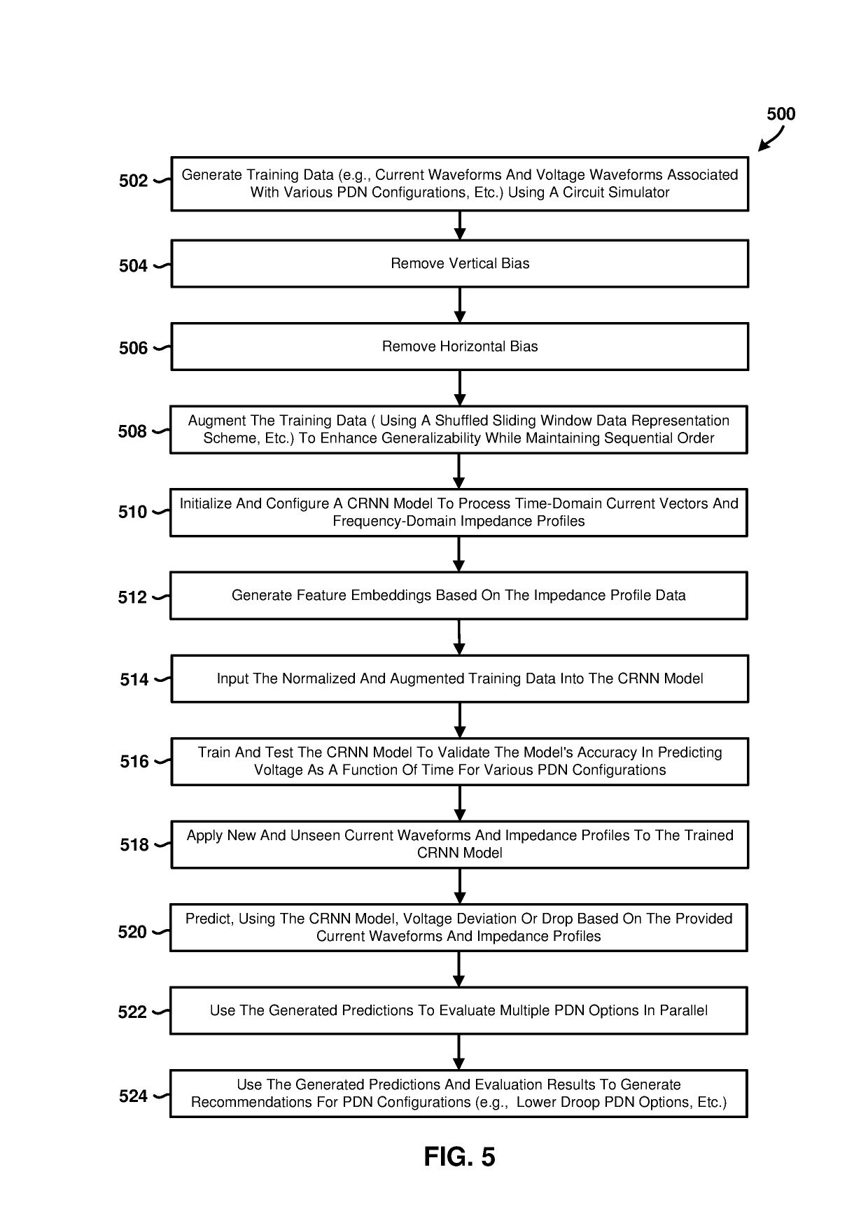

FIG. 5 is a process flow diagram illustrating a method 500 of using AI to improve the efficiency of a PDN simulation in accordance with some embodiments. With reference to FIGS. 1-5, the method 500 may be performed in a computing device by a processing system encompassing one or more, components or subsystems discussed in this application (e.g., the APSEI component, any or all of the processors 110, 112, 114, 116, 118, 121, 122, 121, 122, 152, 160 included in the SIP 100 or SOC 102, 104, etc.). Means for performing the functions of the operations in method 500 may include a processing system including one or more processors and other components described herein. Further, one or more processors of a processing system may be configured with software or firmware to perform some or all of the operations of the method 500. In order to encompass the alternative configurations enabled in various embodiments, the hardware implementing any or all of the method 500 is referred to herein as a “processing system.”

In block 502, the processing system may generate training data using a circuit simulator. For example, the processing system may configure the circuit simulator to model various PDN configurations under different operating conditions. The simulator may run the models to generate current and voltage waveforms that reflect the electrical behavior of the PDN over time.

In some embodiments, the generated training data may include current waveforms and voltage waveforms associated with various PDN configurations. Generating the training data in block 502 may include determining edge DCVS voltage levels for training, which may include specific voltage values DCVS Level 1, DCVS Level 2, DCVS Level 3, DCVS Level 4, and DCVS Level 5, such as but not limited to 556mV, 628mV, 832mV, 904mV, and 988mV. In addition, generating the training data may include determining intermediate DCVS voltage levels for testing the PDN, including values such as but not limited to values intermediate between DCVS Level 2 and DCVS Level 3, and DCVS Level 3 and DCVS Level 4 (such as but not limited to 684mV, 752mV, and 800mV). In some embodiments, the processing system may generate a comprehensive set of training and testing data that allows the CRNN model to accurately predict voltage droop and voltage overshoot across a wide range of operating conditions.

In block 504, the processing system may remove vertical bias from the generated training data. For example, the processing system may adjust the current and voltage waveforms so that all waveforms have a consistent baseline and/or eliminate discrepancies caused by different DC levels.

In some embodiments, the processing system may normalize the current waveforms and/or the voltage waveforms to a consistent DC level (e.g., so that all waveforms are on the same baseline for more accurate comparisons and analyses, etc.). In some embodiments, the processing system may add a DCVS voltage level as an additional feature to account for dynamic voltage changes and/or to further refine the training data for improved model performance.

In block 506, the processing system may remove horizontal bias from the generated training data. For example, the processing system may decompose the current waveforms and the voltage waveforms into individual measurements (e.g., to remove time dependence from the data, etc.). In some embodiments, the processing system may accomplish this by segmenting the waveforms into smaller, discrete data points that capture the instantaneous values of current and voltage at specific moments. This segmentation may allow each data point to be treated independently, reducing the influence of temporal sequences and enhancing the ability of the CRNN model to generalize from the training data.

In block 508, the processing system may augment the training data using a shuffled sliding window data representation scheme to enhance generalizability while maintaining sequential order. For example, the processing system may create overlapping segments (windows) of the original waveform data. Each window may capture a sequence of data points and preserve the temporal order within that segment. In some embodiments, the processing system may shuffle these windows to introduce variability so that the neural network does not learn the data in a fixed order (which may enhance the model’s ability to generalize, etc.). The shuffled windows may be used for training in batches so that the sequence within each window is maintained while the overall order of windows is randomized. This may increase the robustness and effectiveness of the training operations.

In block 510, the processing system may initialize and configure a CRNN model to process time-domain current vectors and frequency-domain impedance profiles. For example, the processing system may set up the CRNN architecture to include an intermediate CNN model for extracting features from the frequency-domain impedance profiles and recurrent layers for handling the sequential nature of the time-domain current vectors. The intermediate CNN model may be a CNN that is used within a larger neural network architecture to specifically extract features from frequency-domain data before it is processed by subsequent layers. This intermediate CNN model may analyze and reduce the dimensionality of the impedance profile data and generate high-dimensional feature embeddings that encapsulate the essential characteristics of the frequency-domain information. In some embodiments, these embeddings may be used by the recurrent layers in the CRNN model to handle the sequential nature of the time-domain current vectors. In some embodiments, the processing system may input a combination of time domain data and the embeddings into the CRNN model to capture temporal dependencies and relationships.

In some embodiments, the processing system may reduce the impedance profile data into feature embeddings. These embeddings may capture the important characteristics of the frequency-domain data. The recurrent layers, such as LSTM or GRU units, may be configured to process these embeddings along with the time-domain current vectors to capture temporal dependencies and relationships. This configuration may allow the CRNN model to accurately predict voltage droop and other relevant metrics.

In some embodiments, as part of the operations in block 510, the processing system may use transfer learning with pre-trained models for generic PDN behavior patterns to learn domain-specific information about specific PDN configurations. Transfer learning may involve initializing the simulation environment to mimic real-world scenarios, generating current waveform data, and normalizing input waveforms to a consistent DC level before inputting the waveforms into the CRNN model.

In block 512, the processing system may generate feature embeddings based on the impedance profile data (e.g., using a CNN model, etc.). For example, the processing system may apply intermediate CNN model(s) to the impedance profile data to extract relevant features. The processing system may convert the raw impedance data into high-dimensional embeddings that encapsulate the essential characteristics of the frequency-domain information.

In some embodiments, as part of the operations in block 510 and 512, the processing system may initialize CRNN models with specific impedance profiles and fine-tune the models using transfer learning techniques. In some embodiments, the processing system may use boundary voltage levels to manage and address variable PDN behavior under different operating conditions. In some embodiments, the processing system may use a combination of pre-training and domain-specific fine-tuning to improve the accuracy and robustness of the PDN simulations.

In block 514, the processing system may input the normalized and augmented training data into the CRNN model. For example, the processing system may feed the time-domain current vectors and the generated feature embeddings from the impedance profiles into the CRNN model. These operations may allow both types of data to be processed simultaneously and capture their interdependencies.

In block 516, the processing system may train and test the CRNN model to validate the model’s accuracy in predicting voltage as a function of time for various PDN configurations. For example, the processing system may train the CRNN model on edge DCVS voltage levels and test the CRNN model on intermediate DCVS voltage levels to validate the accuracy of the CRNN model in predicting voltage as a function of time for various PDN configurations.

In the training phase in block 516, various optimization algorithms may be employed during evaluation phase such as gradient descent methods like stochastic gradient descent (SGD) to minimize loss functions or maximize reward signals. In some embodiments, reinforcement learning techniques may also be used where an agent learns from trial-and-error interactions in a simulated environment and adjusts its policy based on the rewards received.

In block 518, the processing system may apply new and/or unseen current waveforms and impedance profiles to the trained CRNN model. For example, the processing system may input these new data sets into the CRNN model to evaluate its performance on previously unencountered scenarios.

In block 520, the processing system may use the CRNN model to predict voltage droop or drop based on the provided current waveforms and impedance profiles. For example, the processing system may analyze the output of the CRNN model to determine the expected voltage droop across various conditions. This may, in turn, provide insights into potential performance issues.

In block 522, the processing system may use the generated predictions to evaluate multiple PDN options in parallel. For example, the processing system may simultaneously assess different PDN configurations to identify the setups or configurations that minimize or reduce voltage droop and optimize or improve power delivery efficiency.

In block 524, the processing system may use the generated predictions and/or evaluation results to generate recommendations for PDN configurations (e.g., lower droop PDN options, etc.). For example, the processing system may compile the evaluation results into actionable insights and recommend specific PDN configurations that offer the best performance based on the model predictions.

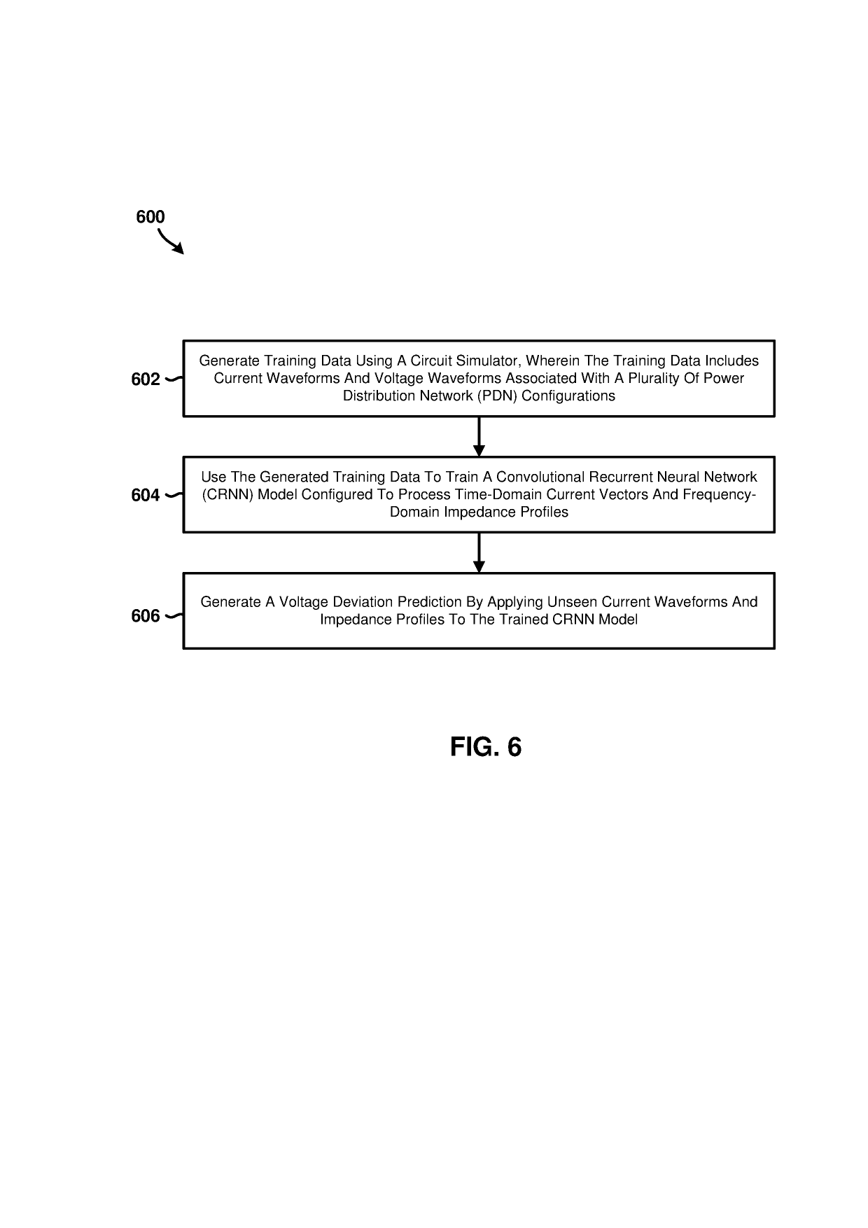

FIG. 6 is a process flow diagram illustrating a method 600 of using AI to improve the efficiency of a PDN simulation in accordance with some embodiments. With reference to FIGS. 1-6, method 600 may be performed in a computing device by a processing system encompassing one or more, components or subsystems discussed in this application (e.g., the APSEI component, any or all of the processors 110, 112, 114, 116, 118, 121, 122, 121, 122, 152, 160 included in the SIP 100 or SOC 102, 104, etc.). Means for performing the functions of the operations in method 600 may include a processing system including one or more processors and other components described herein. Further, one or more processors of a processing system may be configured with software or firmware to perform some or all of the operations of the method 600. In order to encompass the alternative configurations enabled in various embodiments, the hardware implementing any or all of the method 600 is referred to herein as a “processing system.”

In block 602, the processing system may generate training data using a circuit simulator. The training data may include current waveforms and voltage waveforms associated with a plurality of power distribution network (PDN) configurations. In some embodiments, the processing system may simulate various operating conditions to generate waveforms, including dynamic current scaling levels and edge DCVS levels.

In block 604, the processing system may use the generated training data to train a convolutional recurrent neural network (CRNN) model configured to process time-domain current vectors and frequency-domain impedance profiles.

In some embodiments, the processing system may train CRNN models by combining spatial feature extraction and temporal sequence processing using LSTM or GRU units. In some embodiments, the processing system may use intermediate CNN model(s) and/or convolutional layers of the CRNN model to generate feature embeddings from current waveforms and impedance profiles.

In some embodiments, the processing system may use transfer learning with pre-trained models for generic PDN behavior patterns, learning domain-specific knowledge about specific PDN configurations. This may include initializing the simulation environment to mimic real-world scenarios, generating current waveform data, and normalizing input waveforms to a consistent DC level before feeding them into the CRNN model.

In some embodiments, the processing system may initialize CRNN models with specific impedance profiles and fine-tune the models using transfer learning techniques. Edge DCVS levels may be used to handle variable PDN behavior under different operating conditions. Shuffling segments using a shuffled sliding window scheme may enhance generalizability, allowing networks to learn patterns between diverse parts of datasets.

In block 606, the processing system may generate a voltage deviation prediction by applying new or unseen current waveforms and impedance profiles to the trained CRNN model. In some embodiments, the processing system may use optimization algorithms to analyze performance metrics and provide recommendations for optimal PDN configurations. In some embodiments, the processing system may be configured to perform various optimization algorithms (e.g., stochastic gradient descent, etc.) to reduce or minimize loss functions or improve or maximize reward signals.

In some embodiments, the processing system may use a combination of techniques for handling non-linear relationships between input features (e.g., current waveforms and impedance profiles) that are not captured accurately by traditional methods. For example, feature embeddings may improve prediction accuracy by reducing data dimensionality while preserving relevant information.

In some embodiments, various techniques may be employed during the inference phase such as removing vertical bias from input waveforms by normalizing them to a consistent DC level or decomposing individual measurements.

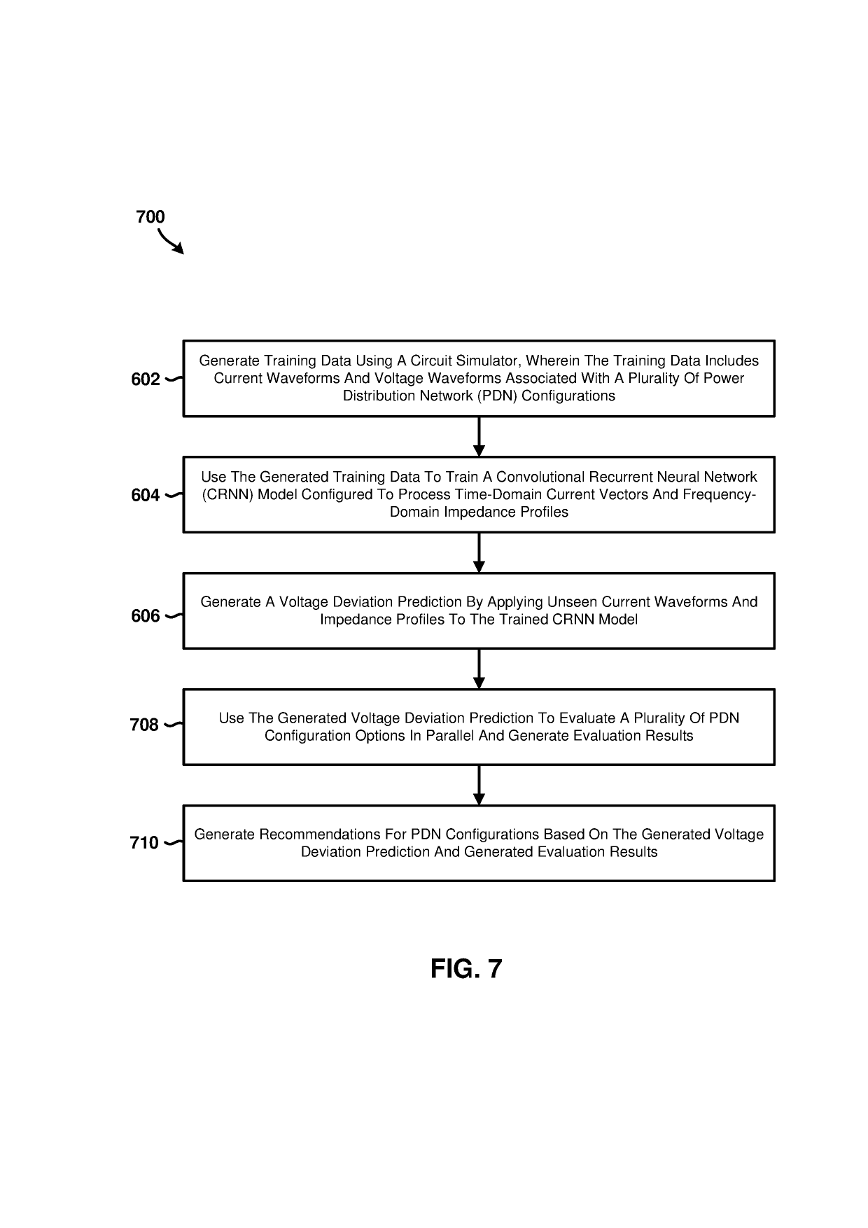

FIG. 7 is a process flow diagram illustrating a method 700 of using AI to improve the efficiency of a PDN simulation in accordance with some embodiments. With reference to FIGS. 1-7, method 700 may be performed in a computing device by a processing system encompassing one or more, components or subsystems discussed in this application (e.g., the APSEI component, any or all of the processors 110, 112, 114, 116, 118, 121, 122, 121, 122, 152, 160 included in the SIP 100 or SOC 102, 104, etc.). Means for performing the functions of the operations in method 700 may include a processing system including one or more processors and other components described herein. Further, one or more processors of a processing system may be configured with software or firmware to perform some or all of the operations of the method 700. In order to encompass the alternative configurations enabled in various embodiments, the hardware implementing any or all of the method 700 is referred to herein as a “processing system.”

In blocks 602-606, the processing system may perform the operations in like-numbered blocks 602-606 illustrated and described with reference to FIG. 6.

In block 708, the processing system may use the generated voltage droop prediction to evaluate a plurality of PDN configuration options in parallel and generate evaluation results that may be used to identify configurations with lower voltage droop. For example, the processing system may analyze different PDN configurations under various operating conditions and compare the predicted voltage droop for each configuration. This comparative analysis may help in identifying PDN configurations that demonstrate lower voltage droop and improved power delivery efficiency. The processing system may present these evaluation results in a format that facilitates easy comparison and selection of optimal PDN configurations.

In block 710, the processing system may generate recommendations for PDN configurations based on the generated voltage droop prediction and generated evaluation results. For example, the processing system may compile the evaluation results into a report that includes recommendations for PDN configurations. Such recommendations may include configurations that offer the improved performance in terms of voltage stability and power delivery efficiency. The report may be tailored to the needs of system designers and provide actionable insights and guidelines for implementing the recommended PDN configurations in various applications.

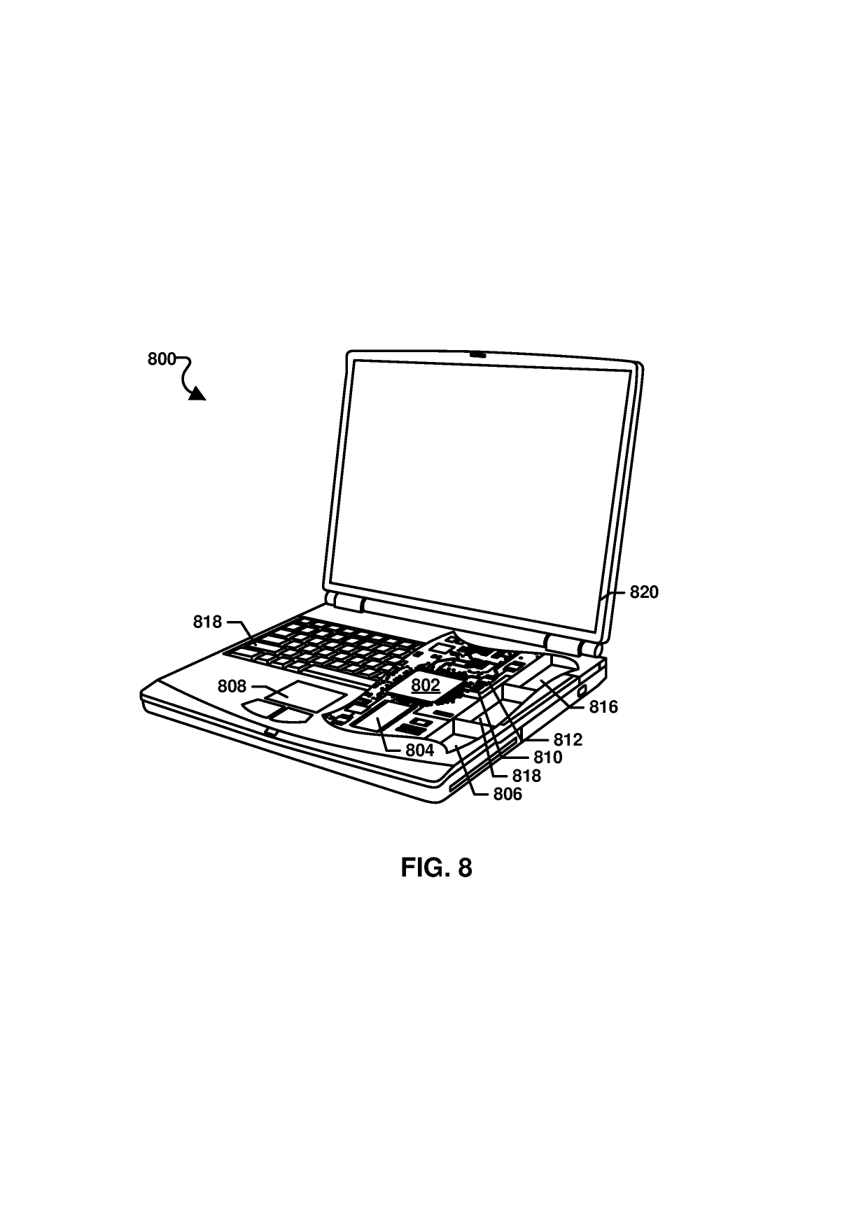

Various embodiments (including, but not limited to, embodiments described above with reference to FIGS. 1-7) may be implemented in a wide variety of wireless devices and computing systems including a laptop computer 800, an example of which is illustrated in FIG. 8. With reference to FIGS. 1-8, a laptop computer may include a processor 802 coupled to volatile memory 804 and a large capacity nonvolatile memory, such as a disk drive 806 of Flash memory. The laptop computer 800 may include a touchpad touch surface 808 that serves as the computer’s pointing device, and thus may receive drag, scroll, and flick gestures. Additionally, the laptop computer 800 may have one or more antenna 810 for sending and receiving electromagnetic radiation that may be connected to a wireless data link and/or cellular telephone transceiver 812 coupled to the processor 802. The computer 800 may also include a compact disc (CD) drive 816, a keyboard 818, and a display 820, all coupled to the processor 802. Other configurations of the computing device may include a computer mouse or trackball coupled to the processor (e.g., via a universal serial bus (USB) input) as are well known, which may also be used in conjunction with various embodiments.

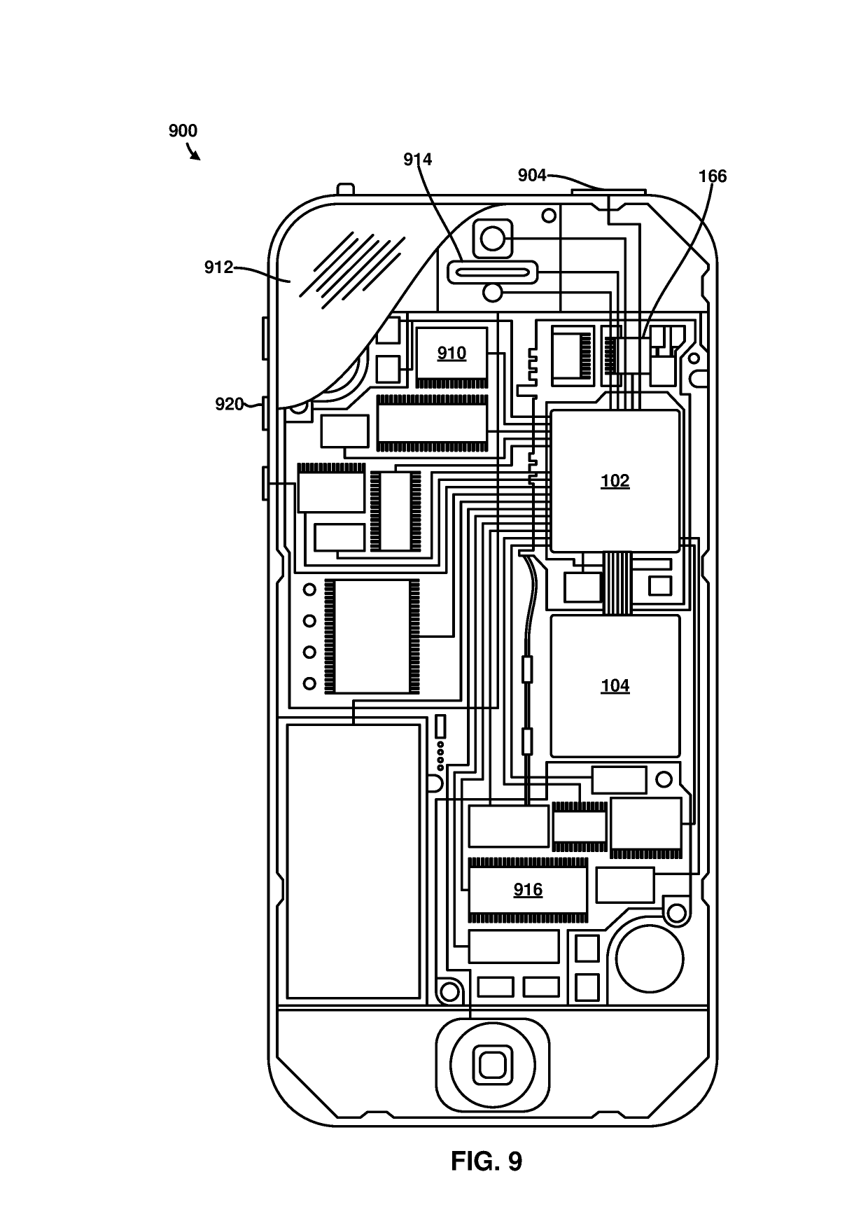

FIG. 9 is a component block diagram of a computing device 900 suitable for use with various embodiments. With reference to FIGS. 1–9, various embodiments may be implemented on a variety of computing devices 900, an example of which is illustrated in FIG. 9 in the form of a smartphone. The computing device 900 may include a first SOC 102 coupled to a second SOC 104. The first and second SoCs 102, 104 may be coupled to internal memory 916, a display 912, and to a speaker 914. The first and second SOCs 102, 104 may also be coupled to at least one subscriber identity module (SIM) 940 and/or a SIM interface that may store information supporting a first 5GNR subscription and a second 5GNR subscription, which support service on a 5G non-standalone (NSA) network.

The computing device 900 may include an antenna 904 for sending and receiving electromagnetic radiation that may be connected to a wireless transceiver 166 coupled to one or more processors in the first and/or second SOCs 102, 104. The computing device 900 may also include menu selection buttons or rocker switches 920 for receiving user inputs.

The computing device 900 also includes a sound encoding/decoding (CODEC) circuit 910, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166 and CODEC 910 may include a digital signal processor (DSP) circuit (not shown separately).

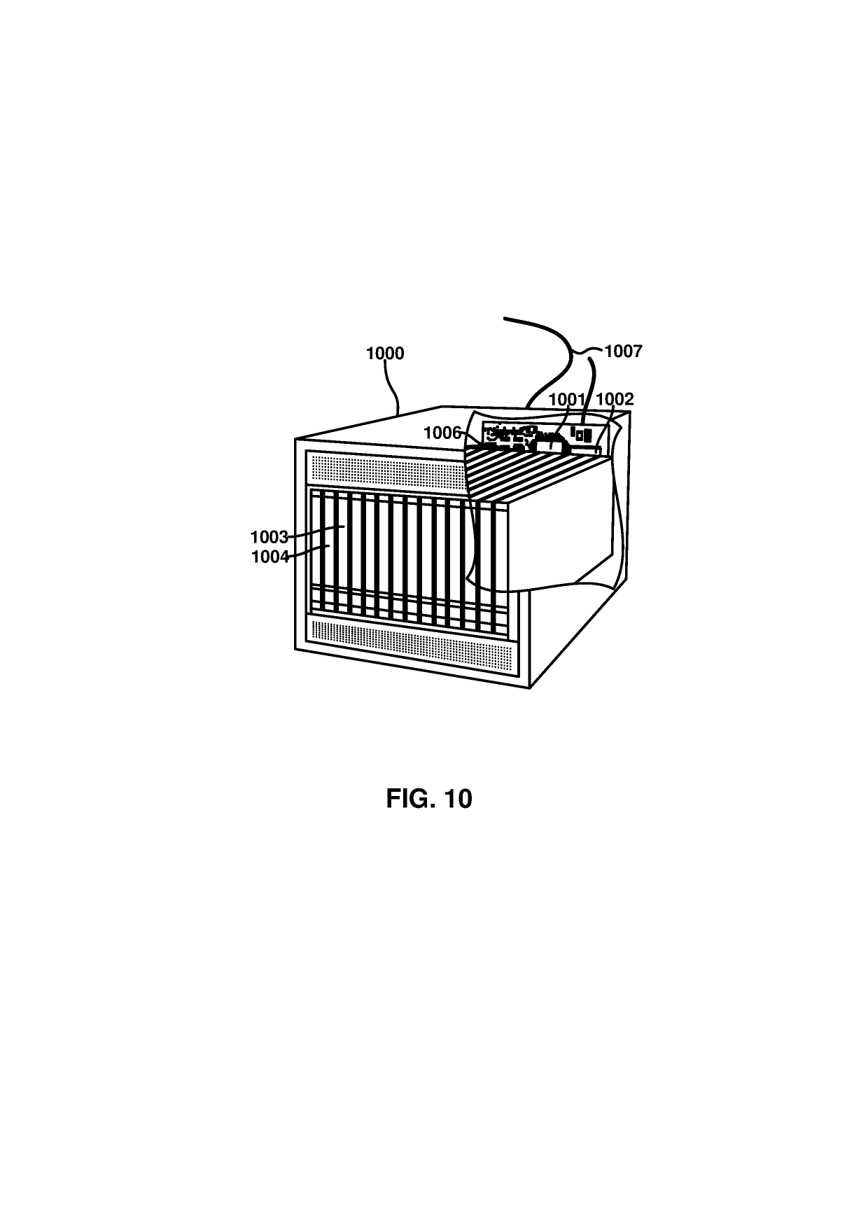

Some embodiments may be implemented on any of a variety of commercially available computing devices, such as the server computing device 1000 illustrated in FIG. 10. Such a server device 1000 may include a processor 1001 coupled to volatile memory 1002 and a large capacity nonvolatile memory, such as a disk drive 1003. The server device 1000 may also include a floppy disc drive, USB, etc. coupled to the processor 1001. The server device 1000 may also include network access ports 1006 coupled to the processor 1001 for establishing data connections with a network connection circuit 1004 and a communication network 1007(e.g., an Internet protocol (IP) network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A computing device, including: a memory; and at least one processor coupled to the memory and configured to: generate training data using a circuit simulator, in which the training data includes current waveforms and voltage waveforms associated with a plurality of power distribution network (PDN) configurations; use the generated training data to train a convolutional recurrent neural network (CRNN) model configured to process time-domain current vectors and frequency-domain impedance profiles; and generate a voltage deviation (i.e., voltage undershoot or droop and/or voltage overshoot) prediction by applying current waveforms and impedance profiles of different PDN configurations to the trained CRNN model.

Example 2. The computing device of example 1, in which the at least one processor is further configured to use the generated voltage deviation prediction to evaluate a plurality of PDN configuration options in parallel and generate evaluation results.

Example 3. The computing device of example 2, in which the at least one processor is further configured to generate recommendations for PDN configurations based on the generated voltage deviation prediction and generated evaluation results.

Example 4. The computing device of any of examples 1-3, in which the at least one processor is further configured so that one or more intermediate CNN models of the CRNN model reduce impedance profile data into feature embeddings; the at least one processor is further configured to input a combination of time domain data and the embeddings to the CRNN model to capture temporal dependencies and relationships.

Example 5. The computing device of any of examples 1-4, in which the at least one processor is further configured to generate training data by performing operations that include determining boundary voltage levels for training the CRNN model and intermediate voltage levels for testing the trained CRNN model.

Example 6. A method of predicting voltage deviation (i.e., voltage undershoot or droop and/or voltage overshoot) in a power distribution network (PDN) configuration, including: generating training data using a circuit simulator, in which the training data includes current waveforms and voltage waveforms associated with a plurality of PDN configurations; using the generated training data to train a convolutional recurrent neural network (CRNN) model configured to process time-domain current vectors and frequency-domain impedance profiles; and generating a voltage deviation prediction by applying current waveforms and impedance profiles of different PDN configurations to the trained CRNN model.

Example 7. The method of example 6, further including using the generated voltage deviation prediction to evaluate a plurality of PDN configuration options in parallel and generate evaluation results.

Example 8. The method of example 7, further including generating recommendations for PDN configurations based on the generated voltage deviation prediction and generated evaluation results.

Example 9. The method of any of examples 6-8, further including: reducing impedance profile data into feature embeddings using one or more intermediate CNN models of the CRNN model; and inputting a combination of time domain data and the embeddings into the CRNN model to capture temporal dependencies and relationships.

Example 10. The method of any of examples 6-9, further including generating training data by performing operations that include determining boundary voltage levels for training the CRNN model and intermediate voltage levels for testing the trained CRNN model.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include digital memory devices, including RAM, ROM, EEPROM, FLASH memory, optical disk storage, magnetic disk storage, or any other medium that may be used to store target program code in the form of instructions or data structures and that may be accessed by a computer. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a memory; and
at least one processor coupled to the memory and configured to:
generate training data using a circuit simulator, wherein the training data includes current waveforms and voltage waveforms associated with a plurality of power distribution network (PDN) configurations;
use the generated training data to train a convolutional recurrent neural network (CRNN) model configured to process time-domain current vectors and frequency-domain impedance profiles; and
generate a voltage deviation prediction by applying current waveforms and impedance profiles of different PDN configurations to the trained CRNN model.

2. The computing device of claim 1, wherein the at least one processor is further configured to use the generated voltage deviation prediction to evaluate a plurality of PDN configuration options in parallel and generate evaluation results.

3. The computing device of claim 2, wherein the at least one processor is further configured to generate recommendations for PDN configurations based on the generated voltage deviation prediction and generated evaluation results.

4. The computing device of claim 1, wherein:
the at least one processor is further configured so that one or more intermediate CNN models of the CRNN model reduce impedance profile data into feature embeddings; and
the at least one processor is further configured to input a combination of time domain data and the embeddings to the CRNN model to capture temporal dependencies and relationships.

5. The computing device of claim 1, wherein the at least one processor is further configured to generate training data by performing operations that include determining boundary voltage levels for training the CRNN model and intermediate voltage levels for testing the trained CRNN model.

6. A method of predicting voltage deviation in a power distribution network (PDN) configuration, comprising:
generating training data using a circuit simulator, wherein the training data includes current waveforms and voltage waveforms associated with a plurality of PDN configurations;
using the generated training data to train a convolutional recurrent neural network (CRNN) model configured to process time-domain current vectors and frequency-domain impedance profiles; and
generating a voltage deviation prediction by applying current waveforms and impedance profiles of different PDN configurations to the trained CRNN model.

7. The method of claim 6, further comprising using the generated voltage deviation prediction to evaluate a plurality of PDN configuration options in parallel and generate evaluation results.

8. The method of claim 7, further comprising generating recommendations for PDN configurations based on the generated voltage deviation prediction and generated evaluation results.

9. The method of claim 6, further comprising:
reducing impedance profile data into feature embeddings using one or more intermediate CNN models of the CRNN model; and
inputting a combination of time domain data and the embeddings into the CRNN model to capture temporal dependencies and relationships.

10. The method of claim 6, further comprising generating training data by performing operations that include determining boundary voltage levels for training the CRNN model and intermediate voltage levels for testing the trained CRNN model.

11. A non-transitory processor-readable medium having stored thereon processor-executable instructions configured to cause a processor to perform operations comprising:
generating training data using a circuit simulator, wherein the training data includes current waveforms and voltage waveforms associated with a plurality of PDN configurations;
using the generated training data to train a convolutional recurrent neural network (CRNN) model configured to process time-domain current vectors and frequency-domain impedance profiles; and
generating a voltage deviation prediction by applying current waveforms and impedance profiles of different PDN configurations to the trained CRNN model.

12. The non-transitory processor-readable medium of claim 11, wherein the stored processor-executable instructions configured to cause a processor to perform operations further comprising using the generated voltage deviation prediction to evaluate a plurality of PDN configuration options in parallel and generate evaluation results.

13. The non-transitory processor-readable medium of claim 12, wherein the stored processor-executable instructions configured to cause a processor to perform operations further comprising generating recommendations for PDN configurations based on the generated voltage deviation prediction and generated evaluation results.

14. The non-transitory processor-readable medium of claim 11, wherein the stored processor-executable instructions configured to cause a processor to perform operations further comprising:
reducing impedance profile data into feature embeddings using one or more intermediate CNN models of the CRNN model; and
inputting a combination of time domain data and the embeddings into the CRNN model to capture temporal dependencies and relationships.

15. The non-transitory processor-readable medium of claim 11, wherein the stored processor-executable instructions configured to cause a processor to perform operations further comprising generating training data by performing operations that include determining boundary voltage levels for training the CRNN model and intermediate voltage levels for testing the trained CRNN model.
